(19) United States
(12) Patent Application Publication
(10) Pub. No.: US 2026/0359660 A1
(43) Pub. Date: Nov. 12, 2026

(54) MULTI-WORKING-CONDITION FAULT DIAGNOSIS METHOD AND SYSTEM FOR NATURAL GAS PIPELINE BASED ON BAYESIAN ADVERSARIAL ATTACK AND SINGLE-SOURCE DOMAIN TRANSFER

(71) Applicant: NORTHEAST PETROLEUM UNIVERSITY, Daqing (CN)

(72) Inventors: Rou SHANG, Daqing (CN); Chuang WANG, Daqing (CN); Hongli DONG, Daqing (CN); Hanbo WANG, Daqing (CN); Shuangqing CHEN, Daqing (CN); Chuang GUAN, Daqing (CN)

(73) Assignee: NORTHEAST PETROLEUM UNIVERSITY, Daqing (CN)

(21) Appl. No.: 19/702,095

(22) Filed: Jun. 9, 2026

Related U.S. Application Data
(63) Continuation of application No. PCT/CN2024/140473, filed on Dec. 19, 2024.

(30) Foreign Application Priority Data
Jun. 4, 2024 (CN) 202410717954.8

(51) Int. Cl. G06N 3/096; G06N 3/047; G06N 3/0475; G06N 3/094; G06N 7/01

(52) U.S. Cl. CPC G06N 3/096; G06N 3/047; G06N 3/0475; G06N 3/094; G06N 7/01

(57) ABSTRACT

A single-source domain transfer fault diagnosis method is to adopt a transfer learning technology to solve a problem of an insufficient generalization ability of existing deep inference models when dealing with pipeline fault diagnosis tasks under different working conditions. Main steps are as follows: an attack sample generator is constructed based on a Bayesian network, aiming to generate attack samples that can induce an inference model to make wrong decisions by adding delicately designed tiny perturbations to input samples, so as to mine and analyze vulnerable points of the inference model; and a domain discriminator is constructed based on the Bayesian network, for assisting in generating attack samples with strong concealment through adversarial learning with the generator.

### CROSS-REFERENCE TO RELATED APPLICATIONS

This application is a continuation of International Application No. PCT/CN2024/140473, filed on Dec. 19, 2024, which claims priority to Chinese Patent Application No. 202410717954.8, filed on Jun. 4, 2024. All of the aforementioned applications are incorporated herein by reference in their entireties.

### TECHNICAL FIELD

The present disclosure relates to the technology of fault diagnosis for natural gas pipelines, and belongs to the technical field of mechanical fault detection and diagnosis, in particular to a multi-working-condition fault diagnosis method and system for a natural gas pipeline based on Bayesian adversarial attack.

### BACKGROUND

Compared with other transportation modes such as highways, railways, waterways, and aviation, pipeline transportation has become the preferred option for natural gas delivery due to its advantages of low cost, minimal loss, and large transportation volume. However, high-pressure natural gas has flammable and explosive characteristics. During large-scale, long-distance and continuous transportation, any breakage or leakage of pipelines may lead to significant economic losses and may trigger public safety accidents. Therefore, in order to ensure the safety and stability of natural gas transportation, the operating performance of the pipelines needs to be comprehensively monitored, and corresponding maintenance or replacement measures are taken in time.

Data-driven deep learning models have recently made remarkable achievements in the field of fault diagnosis due to significant advantages in aspects of intelligence and automation. The deep learning models usually assume that training data and test data satisfy the principle of independent and identical distribution, which means that data distribution characteristics and laws learned by the models during training should be kept consistent with the test data in practical applications. However, due to the changes of factors such as pipeline materials, working environments, and operating conditions, the pipeline transportation state usually presents multi-working-condition characteristics. Data under different working conditions exhibits significant differences in statistical properties, leading to certain differences in distribution characteristics. For a data-driven fault diagnosis model, the difference in distributions under different working conditions means that even if the model is fully trained under one working condition, performance degradation possibly occurs under another working condition. For this problem, how to establish a diagnosis model with a good generalization ability has very important practical engineering significance. In essence, the simplest method is to build a plurality of diagnosis models for different working conditions, but this will obviously significantly increase the workload and timeliness of diagnostic modeling, and will also increase the complexity and cost of model maintenance.

At present, employing a transfer learning technology for learning and analyzing multi-working-condition data is considered as an effective strategy. Transfer learning, as an advanced cross-domain learning method, can effectively utilize the knowledge from a source domain to solve problems in the new domain (target domain) by narrowing differences between different domains. An existing standard transfer learning model requires simultaneous acquisition of source-domain and target-domain data before training to identify and reduce the distribution differences between the two domains during training. However, considering that a natural gas pipeline involves confidential information on oil field energy, any leakage will affect national security. Protecting this sensitive information means that acquiring the target-domain data is extremely difficult.

At present, employing a transfer learning technology for learning and analyzing multi-working-condition data is considered as an effective strategy. Transfer learning, as an advanced cross-domain learning method, can effectively utilize the knowledge from a source domain to solve problems in the new domain (target domain) by narrowing differences between different domains. An existing standard transfer learning model requires simultaneous acquisition of source-domain and target-domain data before training to identify and reduce the distribution differences between the two domains during training. However, considering that a natural gas pipeline involves confidential information on oil field energy, any leakage will affect national security. Protecting this sensitive information means that acquiring the target-domain data is extremely difficult.

Therefore, it is imperative to develop a single-source domain generalization technology for natural gas pipeline fault diagnosis under a plurality of working conditions. This technology should enable model training on a single source domain while equipping the model with a capability to generalize and perform tasks across a plurality of unknown target domains. In the prior art, no one has proposed combining Bayesian adversarial attack and single source domain transfer to realize multi-working-condition fault diagnosis of the natural gas pipeline.

### SUMMARY

In view of the defects in the prior art, a multi-working-condition fault diagnosis method and system for a natural gas pipeline based on Bayesian adversarial attack and single-source-domain transfer are provided, aiming to enhance generalization performance of a diagnosis model by simulating unknown multi-working-condition data through pseudo-domain augmentation, reduce reliance on actual operational data, improve the accuracy of the intelligent fault diagnosis model, and achieve effective diagnosis of faults of the natural gas pipeline under a plurality of working conditions.

A technical solution adopted by the present disclosure to solve the above-mentioned technical problems is as follows.

A multi-working-condition fault diagnosis method for a natural gas pipeline based on Bayesian adversarial attack and single-source domain transfer includes the following steps:

### Step 1: Collect Natural Gas Pipeline Monitoring Signals and Construct a Training Data Set

A pipeline negative pressure wave monitoring signal and an acoustic wave monitoring signal are acquired by using a natural gas pipeline network monitoring system, and a training set

$${𝒟}_{s} = {\{ {x}_{s}^{( i )} , {y}_{s}^{( i )} \}}_{i = 1}^{{N}_{s}}$$

is constructed by using any domain signal, where

$${x}_{s}^{( i )}$$

is an original pipeline sample,

$${y}_{s}^{( i )}$$

is an i-th sample label, and Nₛ is the number of samples.

### Step 2: Establish a Bayesian Generator to Increase Domain Perturbations by Maximizing a Classification Error to Ensure the Effectiveness of the Attack

In order to stabilize training of the Bayesian generator and improve the diversity of attack samples, the present disclosure adopts a Bayesian learning method to marginalize weights of a generative network, thereby introducing uncertainty. To infer a posterior distribution of generator network parameters, sampling may be performed from the following conditional posterior distribution:

p(θ_{g}|xₛ,θ_{d},θ_{c})∝exp(−U_{attack}(θ_{d},θ_{c};xₛ,θ_{g}))p(θ_{g}|α_{g}) (1)

p(θ_{g}|xₛ,θ_{d},θ_{c}) is the posterior distribution of the generator network parameters, and p(θ_{g}|α_{g}) is a prior distribution of the generator network parameters; θ_{g}~p(θ_{g}) represent network parameters of a generator g, θ_{d}~p(θ_{d}) represent network parameters of a discriminator d, and θ_{c}~p(θ_{c}) represent network parameters of a classifier c; and α_{g} is a hyperparameter. U_{attack}(θ_{d},θ_{c};xₛ,θ_{g}) is a loss function of the generator, with a specific form:

$${U}_{a t t a c k} ( {θ}_{d} , {θ}_{c} ; {x}_{s} , {θ}_{g} ) = {\sum }_{i = 1}^{{J}_{g}} ( {\sum }_{m = 1}^{M} log p ( {y}_{d , m}^{( i )} \vert G ( {x}_{s}^{( i )} ; {θ}_{g} ) , {θ}_{d} ) - {\sum }_{n = 1}^{N} log p ( {y}_{c , n}^{( i )} \vert G ( {x}_{s}^{( i )} ; {θ}_{g} ) , {θ}_{c} ) ) \qquad ( 2 )$$

G (xₛ;θ_{g}) represents an attack sample; J_{g} is the number of mini-batch samples for the generator, M is the number of domain labels, and N is the number of category labels; and y_{d,m} represents a domain label, and y_{c,n} represents a fault class label.

Step 3: Establish a Bayesian Discriminator to Ensure the Concealment of the Attack Through Adversarial Learning with the Generator

To infer a posterior distribution of discriminator network parameters, sampling may be performed from the following conditional posterior distribution:

p(θ_{d}|xₛ,θ_{g})∝exp(−U_{discriminate}(θ_{g};xₛ,θ_{d}))p(θ_{d}|α_{d}) (3)

p(θ_{d}|xₛ,θ_{g}) is the posterior distribution of the discriminator network parameters, and α_{d} is a hyperparameter. U_{discriminate}(θ_{g};xₛ,θ_{d}) is a loss function of the discriminator, with a specific form:

$${U}_{discriminate} ( {θ}_{g} ; {x}_{s} , {θ}_{d} ) = - {\sum }_{i = 1}^{{J}_{g}} {\sum }_{m = 1}^{M} ( log p ( {y}_{d , m}^{( i )} \vert {x}_{s}^{( i )} , {θ}_{d} ) + log ( 1 - p ( {y}_{d , m}^{( i )} \vert G ( {x}_{s}^{( i )} ; {θ}_{g} ) , {θ}_{d} ) ) ) \qquad ( 4 )$$

J_{d} is the number of mini-batch samples for the discriminator.

### Step 4: Establish a Bayesian Classifier to Resist the Attack and Improve Generalizability by Expanding a Decision Boundary of an Original Classifier

A defense strategy designed by the present disclosure includes two parts. The first part is a classification loss based on cross entropy. Firstly, a joint distribution p(Xₛ,Yₛ,Xₐ,Yₐ) of original samples and the attack samples needs to be constructed, and then the classification loss is optimized to accurately identify each sample in the joint distribution, namely:

p(θ_{c}|xₛ,xₐ,θ_{g})∝exp(−U_{defense}(θ_{c}))p(θ_{c}|α_{c}) (5)

p(θ_{c}|xₛ,xₐ,θ_{g}) represents a posterior distribution of the classifier network parameters, and α_{c} is a hyperparameter. U_{defense}(θ_{c}) is a loss function of the classifier, with a specific form:

$${U}_{defense} ( {θ}_{c} ) = - {\sum }_{i = 1}^{{J}_{c}} {\sum }_{n = 1}^{N} log p ( {y}_{c , n}^{( i )} \vert {\hat{x}}_{s}^{( i )} , {θ}_{c} ) \qquad ( 6 )$$

\hat{x}_{g}∈p(Xₛ,Yₛ,Xₐ,Yₐ) represents any sample in the joint distribution. The second part is a margin difference loss. A margin is defined as a minimum distance from a data point to the decision boundary. Using the margin difference loss can enlarge a distance between the attack samples and an original decision boundary of the classifier, and constrain the posterior distribution of the classifier network parameters to adjust to a direction of a higher score for the attack samples, so as to enhance the adaptability and robustness of the model when facing distribution differences under different working conditions. A margin-difference-based regularized loss may be represented as:

$${max}_{{θ}_{c}} {ℛ}_{mar} = \frac{1}{{J}_{c}} {\sum }_{i = 1}^{{J}_{c}} {‖ φ ( er {r}_{{p}_{a}}^{( ρ )} ( c ) ) - φ ( {err}_{{p}_{a}}^{( ρ )} ( f ) ) ‖}_{ℋ}^{2} \qquad ( 7 )$$

$$er {r}_{{p}_{a}}^{( ρ )} ( c ) and {err}_{{p}_{a}}^{( ρ )} ( f )$$

represent a transfer classifier margin and a pre-trained classifier margin related to an attack sample distribution p(Xₐ), respectively, and f represents a pre-trained classifier. A specific calculation formula for the margin is:

$$er {r}_{{p}_{a}}^{( ρ )} ( c ) = \frac{1}{n} {\sum }_{i = 1}^{n} {Φ}_{ρ} ( {ρ}_{c} ( {x}_{a}^{( i )} , {y}_{a}^{( i )} ) ) \qquad ( 8 )$$

where ρ_{c}(xₐ,yₐ) is a decision boundary of the classifier, with a calculation method as:

$${ρ}_{c} ( {x}_{a} , {y}_{a} ) {=}^{Δ} \frac{1}{2} ( c ( {x}_{a} , {y}_{a} ) - {max}_{{y}_{a}^{′} = {y}_{a}} c ( {x}_{a} , {y}_{a}^{′} ) ) \qquad ( 9 )$$

$${y}_{a}^{′}$$

is a correct classification label given by the classifier for the attack sample xₐ, and

$${y}_{a}^{′}$$

is a wrong classification label given by the classifier for the attack sample xₐ. Φ_{ρ}(ρ_{c}(xₐ,yₐ)) is a piecewise function, which is configured to promote the classifier to generate a large positive margin value, that is, to make a score of a correct category as high as possible than scores of other categories. A specific form is:

$${Φ}_{ρ} ( {ρ}_{c} ( {x}_{a} , {y}_{a} ) ) {=}^{Δ} \{ \begin{matrix}0 & ρ \leq {ρ}_{c} ( {x}_{a} , {y}_{a} ) \\ 1 − {ρ}_{c} ( {x}_{a} , {y}_{a} ) / ρ & 0 \leq {ρ}_{c} ( {x}_{a} , {y}_{a} ) < ρ \\ 1 & ρ ( {x}_{a} , {y}_{a} ) < 0\end{matrix} \qquad ( 10 )$$

ρ is a margin lower bound.

### Step 5: Estimate a Weight Posterior Distribution Using Stochastic Gradient Hamiltonian Monte Carlo (SGHMC) Sampling

Firstly, a network parameter optimizer is constructed based on the SGHMC, and then the Bayesian generator, the Bayesian discriminator, and the Bayesian classifier are trained alternately.

### Step 6: Obtain a Single-Source Domain Transfer Diagnosis Model and Complete Pipeline Network Fault Type Identification

The training of the single-source domain transfer diagnosis model is completed through the steps 1 to 4, and model performance is evaluated using set test data (from pipelines with operating conditions different from those of training data).

A multi-working-condition fault diagnosis system for a natural gas pipeline based on Bayesian adversarial attack and single-source domain transfer is provided. The system has a program device corresponding to the steps of the technical solution, and the steps of the above-mentioned multi-working-condition fault diagnosis method for a natural gas pipeline based on Bayesian adversarial attack and single-source domain transfer are performed when running.

A computer-readable storage medium stores a computer program, and the computer program is configured to implement the steps of the multi-working-condition fault diagnosis method for a natural gas pipeline based on Bayesian adversarial attack and single-source domain transfer when called by a processor.

A natural gas pipeline multi-working-condition fault diagnosis device includes at least one processor, and a memory which is in communication connection with the at least one processor, where the memory stores instructions executable by the at least one processor, the instructions, when executed by the at least one processor, cause the at least one processor to perform the multi-working-condition fault diagnosis method for a natural gas pipeline based on Bayesian adversarial attack and single-source domain transfer, and implement multi-working-condition fault diagnosis of a natural gas pipeline.

The present disclosure has following beneficial effects.

The multi-working-condition fault diagnosis method and system for a natural gas pipeline based on Bayesian adversarial attack and single-source domain transfer provided in the present disclosure introduce a single-source domain generalization technology. This technology may enable model training on a single source domain and equip the model with a capability to generalize and perform tasks across a plurality of unknown target domains, thereby significantly enhancing identification accuracy and reliability of multi-working-condition fault diagnosis for the natural gas pipeline in a multi-working-condition scenario. The present disclosure provides a domain generalization strategy based on the single-source domain within domain adaptation algorithms. This strategy may train the model on a single source domain in the absence of target-domain data, enabling the model to have the capability to generalize and perform tasks in the plurality of unknown target domains.

A core of a single-source domain generalization algorithm lies in extracting universal features from source-domain samples while excluding features that may cause the model to overfit to specific source domain environments, thereby enhancing model robustness. In this process, according to the present disclosure, it is observed that an attack and defense strategy and domain generalization have essential similarities in principle, and both aim to enhance the robustness of the model in the face of unknown and changing conditions. Firstly, although unknown target-domain data shares the same semantic information as the source-domain samples, the distribution is different, which leads to diagnosis models trained based on the source domain often misclassifying the target-domain data. This phenomenon is similar to a case under attack scenarios, where slight perturbations to the original samples cause misjudgments by the diagnosis model. Therefore, a first conclusion is drawn: for the diagnosis model, both the attack samples and the target-domain data violate an independent and identically distributed assumption.

Further, an objective of single-source domain generalization is to make the diagnosis model perform better on the target domain by eliminating inter-domain differences, while the defense strategy aims to construct a robust diagnosis model that can perform accurate identification even in the face of attack. Based on this, a second conclusion is drawn: both the defense strategy and single-source domain generalization aim to improve the generalization ability and mobility of the diagnosis model to deal with data samples that violate the independent and identically distributed assumption.

Therefore, during the training process of the diagnosis model, all target-domain data that is misidentified during a testing phase is regarded as attack samples with infinite occurrences, and these samples weaken the diagnosis performance of the model through domain perturbations. Meanwhile, the single-source domain generalization essentially defends against this natural attack by reducing domain differences and improving diagnosis accuracy, thereby enhancing the resistance of the model to unknown changes and the generalization ability of the model. In summary, based on the idea of attack and defense, the present disclosure proposes a natural gas pipeline fault diagnosis model based on Bayesian single domain generalization (BSDG), for overcoming small sample challenges.

The contribution of the present disclosure lies in: considering a more general and practical domain adaptation problem, that is, eliminating the need for target-domain data participation in the transfer learning process, and proposing a new perspective to deal with this general domain generalization problem through the attack and defense strategy. The present disclosure is one of the few attempts to apply an attack and defense framework to single-source domain generalization for pipeline fault diagnosis. The algorithm proposed by the present disclosure constructs the domain generalization problem as a two-phase confrontation process, and solves the problem through the carefully designed attack and defense strategy. This work is expected to inspire new ideas and open up a new path for the research in the field of pipeline fault diagnosis; and a Bayesian single-source domain generalization algorithm for fault diagnosis of the natural gas pipelines is proposed. Within a Bayesian inference framework, the algorithm firstly employs the weight-marginalized generator and discriminator to construct the diverse attack samples, aiming to simulate the uncertainty and dynamics of domain bias. Further, the algorithm introduces a defense mechanism based on a margin difference, which enhances the resistance to pseudo-target sample domain-difference attack by extending the decision boundary of a source-domain model, thereby providing an effective solution for a problem about small samples; and in order to validate the effectiveness of the proposed BSDG algorithm in small-sample natural gas pipeline fault diagnosis, the present disclosure selects a variety of advanced comparative algorithms, and carries out detailed comparative analysis from a plurality of dimensions such as diagnosis performance, training stability, and significance differences. Experimental results show that the BSDG algorithm exhibits superior performance in handling domain generalization fault diagnosis tasks.

Compared with the prior art, the following advantages and effects are achieved.

Firstly, different from a conventional intelligent fault diagnosis technology based on a deep learning algorithm, the present disclosure mainly focuses on a problem of model performance degradation in the multi-working-condition scenario urgently solved in the field of pipeline fault diagnosis, and improves the accuracy and practicability of the intelligent fault diagnosis model by providing targeted solutions.

Secondly, different from a standard multi-working-condition fault diagnosis model constructed based on a transfer learning strategy, the present disclosure introduces the attack and defense framework, explains vulnerable points of the fault diagnosis model by generating the attack samples to simulate a multi-working-condition target domain, and further designs the defense strategy for key points of performance degradation to improve the generalization performance of the model, effectively improves the identification accuracy of the model in the multi-working-condition scenario, and avoids the need for a large amount of operational data.

Thirdly, in the present disclosure, the generator, the discriminator, and the classifier are established based on the Bayesian network, the uncertainty is introduced by marginalizing the network parameters, and the diversity of the attack samples is effectively enhanced, thereby enabling better simulation of real-world multi-working-condition distributions. In addition, the Bayesian network can effectively alleviate a problem of overfitting by introducing prior knowledge on the weights and updating the weights to a posterior distribution, helping the classifier to flexibly adapt to new situations and data changes.

Lastly, considering the current practical application of the intelligent fault diagnosis technology, this method has a practical application value and currently achieves certain application results.

### BRIEF DESCRIPTION OF THE DRAWINGS

FIG. 1 is a flow block diagram of multi-working-condition fault diagnosis according to an embodiment of the present disclosure.

FIG. 2 is a network structure diagram according to an embodiment of the present disclosure.

FIG. 3 is a graph of loss convergence and validation accuracy according to an embodiment of the present disclosure.

FIG. 4a is a flowchart of Generator training and attack sample generation based on Bayesian inference.

FIG. 4b is a flowchart of Source-domain classification model training and domain generalization based on margin difference.

FIG. 5 is a partial photograph of an HD-II console and pipeline platform.

### DETAILED DESCRIPTION OF THE EMBODIMENTS

The technical solutions in the embodiments of the present disclosure will be described clearly and completely below.

The present disclosure is further described below in conjunction with the accompanying drawings.

To enable those skilled in the art to better understand technical solutions in this application, the technical solutions in embodiments of this application will be described clearly and completely below in conjunction with the accompanying drawings in the embodiments of this application.

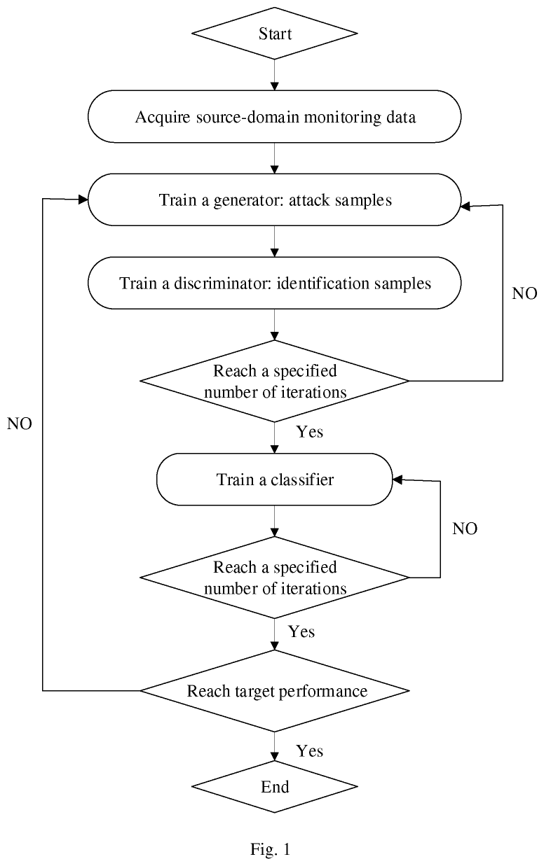

FIG. 1 is a flow block diagram of multi-working-condition fault diagnosis for a natural gas pipeline based on Bayesian adversarial attack in the technical solution of the present disclosure, and the overall flow is implemented by Pytorch language programming.

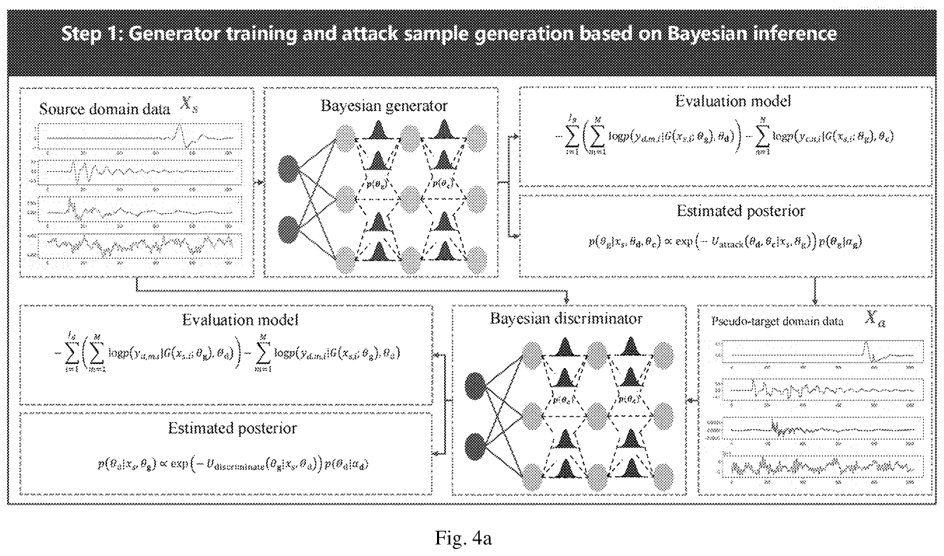

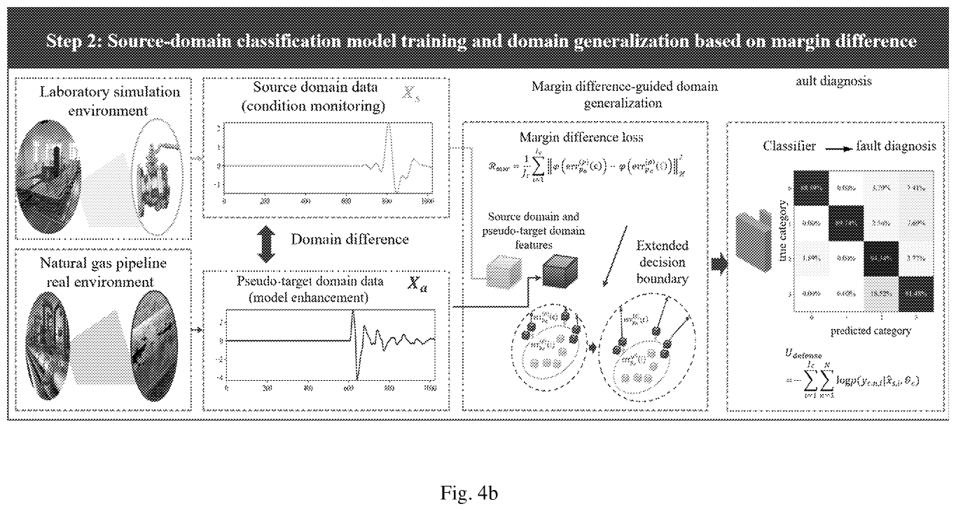

In an attack-defense framework, the present disclosure adopts Bayesian inference and margin discrepancy as key tools, and constructs a single-source domain generalization model for a fault diagnosis task of the natural gas pipeline. A BSDG framework is shown in FIG. 4 and includes two phases: attack and defense.

The present disclosure designs an attack strategy based on Bayesian generative adversarial networks (BGANs), with a key idea for generating attack samples with domain perturbation through the BGANs, and improving a success rate of attack by misleading an update direction of classifier network parameters. Specifically, the BGAN is composed of two parts: a Bayesian generator and a Bayesian discriminator. The generator tries to generate attack samples similar to source-domain samples to deceive the discriminator, while the discriminator strives to improve a capability of identifying the attack samples. Through this adversarial process, the generator successfully learns and outputs the attack samples that are indistinguishable from the source-domain samples. A basic framework of a BGAN model comes from a GAN proposed by Ian Goodfellow et al. [13] in 2014. However, an optimization objective of a standard GAN easily falls into mode collapse, that is, the feedback given by the discriminator cannot sufficiently guide the generator to generate diverse samples, resulting in the generator tending to only focus on generating a limited number of sample types.

In order to stabilize BGAN training and improve the diversity of the attack samples, the present disclosure adopts a Bayesian learning method, that is, uncertainty is introduced by marginalizing weights of generator and discriminator networks. In a neural network, all weights may be characterized by a highly multimodal posterior distribution, rather than having only one fixed value, as is typically the case. Each mode in a posterior distribution of the network weights may correspond to a different generator, with each generator exhibiting a specific data generation behavior. Therefore, unlike the standard GAN, the BGAN constructs a collection of generator networks, effectively enhancing the diversity of the attack samples and enabling more comprehensive and accurate simulation of unknown target domains. In addition, a collection of discriminator networks can amplify adversarial signals, further enhancing an identifying capability of the discriminator in complex attack scenarios.

Domain generalization mainly focuses on how to train one diagnosis model with the source-domain samples so that the model can generalize to any unknown target domain. According to the existing research work, the domain generalization is mainly divided into two settings: single-source domain generalization (SSDG) and multi-source domain generalization (MSDG). In the SSDG setting, the model is only trained on a single source domain and is expected to be able to generalize to any unknown target domain. In the MSDG setting, the model is trained on a plurality of source domains, and the generalization ability to the unknown target domain is enhanced by improving the adaptability to distribution differences between the plurality of source domains. However, the MSDG setting typically requires collecting samples from three or more source domains to improve generalization performance, but this requirement is often difficult to meet in the field of pipeline fault diagnosis. Therefore, the present disclosure focuses primarily on the SSDG setting.

Single-source domain generalization: Different from the MSDG setting, the distribution differences between the plurality of source domains may be learned to improve the adaptability of the model. Due to the lack of relevant information of the target domain, most existing researches under the SSDG setting primarily focus on utilizing a data enhancement technology to generate diverse pseudo-target domain data. For example, Cugu et al. vary training set samples to simulate new domains by applying consistent visual attention to different views of the same sample. Su et al. generate enhancement samples with more diversity and information by combining global and local position scale transformations and using saliency information to guide an enhancement process. Zheng et al. [10] conceptualizes standard data enhancement (transformation or inversion) that may have learning parameters as semantic transformation, and further utilizes semantic transformation to enhance the source-domain samples. Li et al. utilize a domain extension subnetwork to gradually generate a plurality of domains to simulate various photometric and geometric transformations in unseen domains, thus expanding the coverage of the source domain. However, existing researches on domain generalization based on data enhancement lacks a clear definition of a pseudo-target domain, which often leads to excessive (no correlation) or small difference (no domain difference) between pseudo-domain samples and real samples, which in turn affects transfer performance and even leads to negative transfer. In order to solve this problem, the present disclosure introduces an attack and defense strategy, defines a path of pseudo-target domain enhancement by using an existing attack sample definition, ensures that the pseudo-domain samples not only retain the correlation with the source domain, but also introduce sufficient domain differences to simulate potential target domains, thereby improving the generalization ability and transfer performance of the model.

Bayesian neural network: In a standard neural network, each weight and bias is set to a fixed value. These values are learned and adjusted through an optimization process on a training set. In contrast, weights and biases of the Bayesian neural network are treated as probability distributions, and an optimization objective is to estimate a posterior distribution of the weights, which gives the Bayesian neural network the ability to estimate uncertainties, robustness against overfitting, and the ability to resist attack. However, estimating the posterior distribution of the weights is often difficult to implement directly. At present, the main work focuses on variational inference, local reparameterization, Markov chain Monte Carlo, and other technologies. Considering the need for diversity in generated samples, the present disclosure adopts stochastic gradient Hamiltonian Monte Carlo (SGHMC) sampling to estimate the posterior distribution of the weights, thereby avoiding the influence of asymmetric bias introduced by Kullback-Leibler (KL) divergence on methods such as variational approximation.

From the analysis of the introduction, it is found that all the target-domain data exhibits the following features: 1) a feature distribution is different from the source-domain samples; and 2) semantic information is the same as the source-domain samples. This means that although the target domain and the source domain differ in discriminant features, overall trends and category spaces of the target domain and the source domain remain consistent. In view of this characteristic, the present disclosure employs an adversarial attack similar to a domain adaptation principle as a research framework. This type of attack tricks the model into making wrong decisions by adding delicately designed tiny perturbations to input samples. A principle for designing perturbations in adversarial attack includes: 1) concealment: the perturbations usually need to be small enough that a modified sample has little visible difference from an original sample; 2) validity: the perturbations need to be valid enough to make a deep learning model make wrong classifications; 3) mobility: the perturbations should have a certain mobility, which means that adversarial samples effective on one model may also produce misleading effects on other models; and 4) diversity: diversified perturbations may more comprehensively test the resistance of the model to various attacks, help reveal possible weaknesses of the model, and thus promote the development of more robust models.

Based on the above-mentioned description, the present disclosure assumes that a set of related domains { [symbol] , [symbol] } that share a label space exist. [symbol] represents an available source domain, and [symbol] represents an unknown target domain. In the source domain, a sample label pair in a sample space follows a joint distribution p(X,Y), where X and Y represent a sample and a label, respectively. An objective of domain generalization is to learn a classification model c: X→Y by using a sample label pair p(Xₛ,Yₛ)⊂ [symbol] in all source domains. An objective of the classification model is to generalize to an unknown target domain p(Xₜ,Yₜ)∈ [symbol] with superior performance. In order to achieve this objective, the present disclosure designs a BSDG algorithm under the framework of the attack and defense strategy.

An implementation process of the attack strategy of the BSDG is as follows. Referring to FIG. 1, a provided multi-working-condition fault diagnosis method for a natural gas pipeline based on Bayesian adversarial attack includes the following steps:

### Step 1: Collect Natural Gas Pipeline Monitoring Signals and Construct a Training Data Set

A pipeline negative pressure wave monitoring signal and an acoustic wave monitoring signal are acquired by using a natural gas pipeline network monitoring system, and a training set

$${𝒟}_{s} = {\{ {x}_{s}^{( i )} , {y}_{s}^{( i )} \}}_{i = 1}^{{N}_{s}}$$

is constructed by using any domain signal, where

$${x}_{s}^{( i )}$$

is an i-th original pipeline sample,

$${y}_{s}^{( i )}$$

is an i-th sample label, and N₃ is the number of samples.

### Step 2: Establish a Bayesian Generator to Increase Domain Perturbations by Maximizing a Classification Error to Ensure the Effectiveness of the Attack

In order to stabilize training of the Bayesian generator and improve the diversity of the attack samples, the present disclosure adopts the Bayesian learning method to marginalize weights of a generative network, thereby introducing uncertainty. To infer a posterior distribution of generator network parameters, sampling may be performed from the following conditional posterior distribution:

p(θ_{g}|xₛ,θ_{d},θ_{c})∝exp(−U_{attack}(θ_{d},θ_{c}|xₛ,θ_{g}))p(θ_{g}|α_{g}) (1)

p(θ_{g}|xₛ,θ_{d},θ_{c}) is the posterior distribution of the generator network parameters, and p(θ_{g}|α_{g}) is a prior distribution of the generator network parameters; θ_{g}~p(θ_{g}) represent network parameters of a generator g, θ_{d}~p(θ_{d}) represent network parameters of a discriminator d, and θ_{c}~p(θ_{c}) represent network parameters of a classifier c; and α_{g} is a hyperparameter. U_{attack}(θ_{d},θ_{c}|xₛ,θ_{g}) is a loss function of the generator, with a specific form:

$${U}_{a t t a c k} ( {θ}_{d} , {θ}_{c} \vert {x}_{s} , {θ}_{g} ) = - {\sum }_{i = 1}^{{J}_{g}} ( {\sum }_{m = 1}^{M} log p ( {y}_{d , m}^{( i )} \vert G ( {x}_{s}^{( i )} ; {θ}_{g} ) , {θ}_{d} ) - {\sum }_{n = 1}^{N} log p ( {y}_{c , n}^{( i )} \vert G ( {x}_{s}^{( i )} ; {θ}_{g} ) , {θ}_{c} ) ) \qquad ( 2 )$$

G(xₛ;θ_{g}) represents an attack sample; J_{g} is the number of mini-batch samples for the generator, M is the number of domain labels, and N is the number of category labels; and y_{d,m} represents a domain label, and y_{c,n} represents a fault class label.

Step 3: Establish a Bayesian Discriminator to Ensure the Concealment of the Attack Through Adversarial Learning with the Generator

To infer a posterior distribution of discriminator network parameters, sampling may be performed from the following conditional posterior distribution:

p(θ_{d}|xₛ,θ_{g})∝exp(−U_{discriminate}(θ_{g};xₛ,θ_{d}))p(θ_{d}|α_{d}) (3)

p(θ_{d}|xₛ,θ_{g}) is the posterior distribution of the discriminator network parameters, and α_{d} is a hyperparameter. U_{discriminate}(θ_{g}; xₛ,θ_{d}) is a loss function of the discriminator, with a specific form:

$${U}_{discriminate} ( {θ}_{g} ; {x}_{s} , {θ}_{d} ) = - {\sum }_{i = 1}^{{J}_{g}} {\sum }_{m = 1}^{M} ( log p ( {y}_{d , m}^{( i )} \vert {x}_{s}^{( i )} , {θ}_{d} ) + log ( 1 - p ( {y}_{d , m}^{( i )} \vert G ( {x}_{s}^{( i )} ; {θ}_{g} ) , {θ}_{d} ) ) ) \qquad ( 4 )$$

J_{d} is the number of mini-batch samples for the discriminator.

### Step 4: Establish a Bayesian Classifier to Resist the Attack and Improve Generalizability by Expanding a Decision Boundary of an Original Classifier

The defense strategy designed by the present disclosure includes two parts. The first part is a classification loss based on cross entropy. Firstly, a joint distribution p(Xₛ,Yₛ,Xₐ,Yₐ) of original samples and the attack samples needs to be constructed, and then the classification loss is optimized to accurately identify each sample in the joint distribution, namely:

p(θ_{c}|xₛ,xₐ,θ_{g})∝exp(−U_{defense}(θ_{c}))p(θ_{c}|α_{c}) (5)

p(θ_{c}|xₛ,xₐ,θ_{g}) represents a posterior distribution of the classifier network parameters, and α_{c} is a hyperparameter. U_{defense}(θ_{c}) is a loss function of the classifier, with a specific form:

$${U}_{defense} ( {θ}_{c} ) = - {\sum }_{i = 1}^{{J}_{c}} {\sum }_{n = 1}^{N} log p ( {y}_{c , n}^{( i )} \vert {\hat{x}}_{s}^{( i )} , {θ}_{c} ) \qquad ( 6 )$$

\hat{x}ᵢ∈p(Xₛ,Yₛ,Xₐ,Yₐ) represents any sample in the joint distribution. The second part is a margin difference loss. A margin is defined as a minimum distance from a data point to the decision boundary. Using the margin difference loss can enlarge a distance between the attack sample and an original decision boundary of the classifier, and constrain the posterior distribution of the classifier network parameters to adjust to a direction of a higher score for the attack sample, so as to enhance the adaptability and robustness of the model when facing distribution differences under different working conditions. A margin-difference-based regularized loss may be represented as:

$${max}_{{θ}_{c}} {ℛ}_{mar} = \frac{1}{{J}_{c}} {\sum }_{i = 1}^{{J}_{c}} {‖ φ ( {err}_{{p}_{a}}^{( ρ )} ( c ) ) - φ ( {err}_{{p}_{a}}^{( ρ )} ( f ) ) ‖}_{ℋ}^{2} \qquad ( 7 )$$

$${err}_{{p}_{a}}^{( ρ )} ( c ) and {err}_{{p}_{a}}^{( ρ )} ( f )$$

represent a transfer classifier margin and a pre-trained classifier margin related to an attack sample distribution p(Xₐ), respectively, and f represents a pre-trained classifier. A specific-calculation formula for the margin is:

$${err}_{{p}_{a}}^{( ρ )} ( c ) = \frac{1}{n} {\sum }_{i = 1}^{n} {Φ}_{ρ} ( {ρ}_{c} ( {x}_{a}^{( i )} , {y}_{a}^{( i )} ) ) \qquad ( 8 )$$

ρ_{c}(xₐ,yₐ) is the decision boundary of the classifier, with a calculation method as:

$${ρ}_{c} ( {x}_{a} , {y}_{a} ) {=}^{Δ} \frac{1}{2} ( c ( {x}_{a} , {y}_{a} ) - {max}_{{y}_{a}^{′} = {y}_{a}} c ( {x}_{a} , {y}_{a}^{′} ) ) \qquad ( 9 )$$

$${y}_{a}^{′}$$

is a correct classification label given by the classifier for the attack sample xₐ, and y′ₐ is a wrong classification label given by the classifier for the attack sample xₐ. Φₚ(ρ_{c}(xₐ,yₐ)) is a piecewise function, which is configured to promote the classifier to generate a large positive margin value, that is, to make a score of a correct category as high as possible than scores of other categories. A specific form is:

$${Φ}_{ρ} ( {ρ}_{c} ( {x}_{a} , {y}_{a} ) ) {=}^{Δ} \{ \begin{matrix}0 & ρ \leq {ρ}_{c} ( {x}_{a} , {y}_{a} ) \\ 1 - {ρ}_{c} ( {x}_{a} , {y}_{a} ) / ρ & 0 \leq {ρ}_{c} ( {x}_{a} , {y}_{a} ) < ρ \\ 1 & ρ ( {x}_{a} , {y}_{a} ) < 0\end{matrix} \qquad ( 10 )$$

ρ is a margin lower bound.

### Step 5: Estimate a Weight Posterior Distribution Using Stochastic Gradient Hamiltonian Monte Carlo (SGHMC) Sampling

Firstly, a network parameter optimizer is constructed based on the SGHMC, and then the Bayesian generator, the Bayesian discriminator, and the Bayesian classifier are trained alternately.

### Step 6: Obtain a Single-Source Domain Transfer Diagnosis Model and Complete Pipeline Network Fault Type Identification

The training of the single-source domain transfer diagnosis model is completed through the steps 1 to 5, and model performance is evaluated using set test data (from pipelines with operating conditions different from those of training data).

In step 1, a specific process of acquiring the pipeline negative pressure wave monitoring signal and the acoustic wave monitoring signal, and constructing the training set by using any domain signal is as follows: firstly, the negative pressure wave monitoring signal and the acoustic wave monitoring signal are respectively acquired from the monitoring system, then a sample having a length of 1024 is acquired through a downsampling operation, the acquired sample is denoised, and finally the negative pressure wave signal and the acoustic wave signal are stored as two separate domains. In step 2, the hyperparameter α_{g} is determined according to cross-validation. A relationship between the network parameters of the generator g, the network parameters of the discriminator d, and the network parameters of the classifier c is that an output result of the discriminator is configured to adjust an update direction of the generator, and a result of the generator is configured to improve the generalization performance of the classifier. In step 3, the hyperparameter α_{d} determined according to cross-validation. In step 4, the margin lower bound ρ is related to model accuracy, which is determined through a plurality of experiments. In step 5, the Bayesian network parameter optimizer is constructed using the stochastic gradient Hamiltonian Monte Carlo method to realize the alternating optimization of the generator, the discriminator, and the classifier. A specific process of constructing the Bayesian network parameter optimizer using the stochastic gradient Hamiltonian Monte Carlo (SGHMC) method to realize the alternating optimization of the generator, the discriminator, and the classifier is as follows:

According to a previous round of iteration process, parameters θ_{g},θ_{d},θ_{c} that need to be currently updated are obtained:

$${\{ {θ}_{g}^{i , k} \}}_{i = 1 , k = 1}^{{J}_{g} , K} , {\{ {θ}_{d}^{i , k} \}}_{i = 1 , k = 1}^{{J}_{d} , K} and {\{ {θ}_{c}^{i , k} \}}_{i = 1 , k = 1}^{{J}_{c} , K}$$

Then, an attack training loop is started:

J_{g} times of SGHMC training are started, J_{g} source-domain samples

$$\{ {x}_{s}^{( 1 )} , {x}_{s}^{( 2 )} , ⋯ , {x}_{s}^{( {J}_{g} )} \}$$

are sampled from a source-domain distribution p(Xₛ), and a parameter posteriori distribution p(θ_{g}|xₛ,θ_{d}) is updated through K iterations of the SGHMC.

$${θ}_{g}^{i , k} ← {θ}_{g}^{i , k} + v ; v ← ( 1 - α ) v + η \frac{\partial ( {\sum }_{i} {\sum }_{k} p ( {θ}_{g} \vert {x}_{s}^{( i )} , {θ}_{d}^{i , k} , {θ}_{c}^{i , k} ) )}{\partial {θ}_{g}} + n ; n ∼ 𝒩 ( 0 , 2 αη I )$$

$${θ}_{g}^{i , k}$$

is added to a parameter set to end the loop.

J_{d} iterations of SGHMC training are started:

J_{d} source-domain samples

$$\{ {x}_{s}^{( 1 )} , {x}_{s}^{( 2 )} , ⋯ , {x}_{s}^{( {J}_{d} )} \}$$

are sampled from the source-domain distribution, and a parameter posteriori distribution p(θ_{d}|xₛ,θ_{g}) is updated through K iterations of the SGHMC.

$${θ}_{d}^{i , k} ← {θ}_{d}^{i , k} + v ; v ← ( 1 - α ) v + η \frac{\partial ( {\sum }_{i} {\sum }_{k} p ( {θ}_{d} \vert {x}_{s}^{( i )} , {θ}_{g}^{i , k} ) )}{\partial {θ}_{d}} + n ; n ∼ 𝒩 ( 0 , 2 αη I )$$

$${θ}_{d}^{i , k}$$

is added to the parameter set to end the attack training loop.

Then, a defense training loop is started:

J_{c} augmented samples

$$\{ {\hat{x}}_{s}^{( 1 )} , {\hat{x}}_{s}^{( 2 )} , ⋯ , {\hat{x}}_{s}^{( {J}_{c} )} \}$$

are sampled from a joint domain distribution p(Xₛ,Xₐ), and a parameter posteriori distribution p(θ_{c}|xₛ,xₐ,θ_{g}) is updated through K iterations of the SGHMC.

$${θ}_{c}^{i , k} ← {θ}_{c}^{i , k} + v ; v ← ( 1 - α ) v + η \frac{\partial ( {\sum }_{i} {\sum }_{k} p ( {θ}_{c} \vert {x}_{s}^{( i )} , {x}_{a}^{( i )} , {θ}_{g}^{i , k} ) - {ℛ}_{mar} )}{\partial {θ}_{c}} + n ; n ∼ 𝒩 ( 0 , 2 αη I )$$

The defense training loop is ended.

In the above-mentioned formula, α is a momentum attenuation coefficient of the SGHMC, η is a learning rate, v=ϵM⁻¹r is a kinetic energy term of the SGHMC, and 2αηI represents a variance. Specific algorithms are shown as follows.

Algorithm 1 One iteration of training: α is the momentum attenuation coefficient of the SGHMC, η is the learning rate, and v=ϵM^{|1}r is the kinetic energy term of the SGHMC. Represent posteriors with samples

$${\{ {θ}_{g}^{i , k} \}}_{i = 1 , k = 1}^{{J}_{g ,} K} , {\{ {θ}_{d}^{i , k} \}}_{i = 1 , k = 1}^{{J}_{d ,} K} and {\{ {θ}_{c}^{i , k} \}}_{i = 1 , k = 1}^{{J}_{c ,} K}$$

from previous iterations
Start the attack training loop
Start J_{g} training of MC
Sample J_{y} source-domain samples

$$\{ {x}_{s}^{( 1 )} , {x}_{s}^{( 2 )} , … , {x}_{s}^{( {J}_{g} )} \}$$

from the source-domain distribution p(Xₛ)
Update the parameter posteriori distribution p(θ_{g}|xₛ,θ_{d}) through K iterations of the SGHMC

$${θ}_{g}^{i , k} ← {θ}_{g}^{i , k} + v ; v ← ( 1 - α ) v + η \frac{\partial ( {\sum }_{i} {\sum }_{k} p ( {θ}_{g} \vert {x}_{s}^{( i )} , {θ}_{d}^{i , k} , {θ}_{c}^{i , k} ) )}{\partial {θ}_{g}} + n ;$$

$$n ∼ \text{?} ( 0 , 2 α η I )$$

Add

$${θ}_{g}^{i , k}$$

to the parameter set
End the loop
Start J_{d} training of MC
Sample J_{d} source-domain samples

$$\{ {x}_{s}^{( 1 )} , {x}_{s}^{( 2 )} , … , {x}_{s}^{( {J}_{d} )} \}$$

from the source-domain distribution
Update the parameter posteriori distribution p(θ_{d}|xₛ,θ_{g}) through K iterations of the SGHMC

$${θ}_{d}^{i , k} ← {θ}_{d}^{i , k} + v ; v ← ( 1 - α ) v + η \frac{\partial ( {\sum }_{i} {\sum }_{k} p ( {θ}_{d} \vert {x}_{s}^{( i )} , {θ}_{g}^{i , k} ) )}{\partial {θ}_{d}} + n ;$$

$$n ∼ \text{?} ( 0 , 2 α η I )$$

Add

$${θ}_{d}^{i , k}$$

to the parameter set
End the loop
End the loop
Start the defense training loop
Sample J_{c} augmented samples

$$\{ {\hat{x}}_{s}^{( 1 )} , {\hat{x}}_{s}^{( 2 )} , … , {\hat{x}}_{s}^{( {J}_{c} )} \}$$

from the joint domain distribution p(Xₛ,Xₐ)
Update the parameter posteriori distribution p(θ_{c}|xₛ,xₐ,θ_{g}) through K iterations of the SGHMC.

$${θ}_{c}^{i , k} ← {θ}_{c}^{i , k} + v ; v ← ( 1 - α ) v + η \frac{\partial ( {\sum }_{i} {\sum }_{k} p ( {θ}_{c} \vert {x}_{s}^{( i )} , {x}_{a}^{( i )} , {θ}_{g}^{i , k} ) - {\text{?}}_{mar} )}{\partial {θ}_{c}} + n ;$$

$$n ∼ \text{?} ( 0 , 2 α η I )$$

End the loop

### EMBODIMENT

Taking natural gas pipeline fault diagnosis as a case, the effectiveness of the method of the present disclosure is verified.

### 1. Experimental Setup

The training data used in the present disclosure is collected from a pressure sensor in a ZJ-CSDG pipeline simulation platform and an acoustic wave sensor in an HD-II pipeline simulation platform, respectively. The ZJ-CSDG pipeline simulation platform has a total length of 180.2 m, a flow rate of 10 m³/h, and a sampling frequency of 1024 Hz. Negative pressure wave data is collected under three working pressures, namely a high pressure (HP) domain within a range of 0.565 MPa to 0.595 MPa, a medium pressure (MP) domain within a range of 0.425 MPa to 0.455 MPa, and a low pressure (LP) domain within a range of 0.275 MPa to 0.305 MPa. Under each pressure condition, the experimental data simulates four health states of a pipeline by adjusting a valve opening degree, namely large leakage, medium leakage, small leakage, and a normal condition.

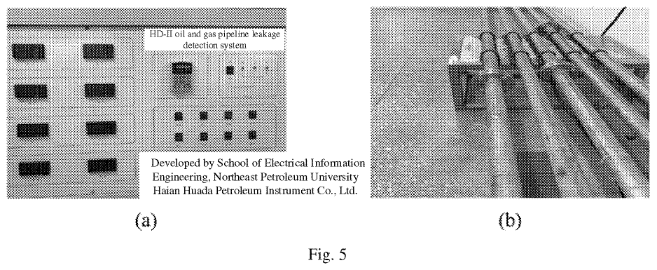

The HD-II pipeline simulation platform (shown in FIG. 5) has a total length of 160 m, a pressure of 0.5 Mpa, a flow rate of 60 m³/h, and 10 leakage points. Four pipeline health conditions are set for pipeline fault types, including the large leakage (LL), the medium leakage (ML), the small leakage (SL), and the normal condition (NC). Considering a fault sampling frequency, a length of an intercepted sample needs to include at least one period of a fault frequency, thus intercepting 1024 sampling points from an original signal to form one sample.

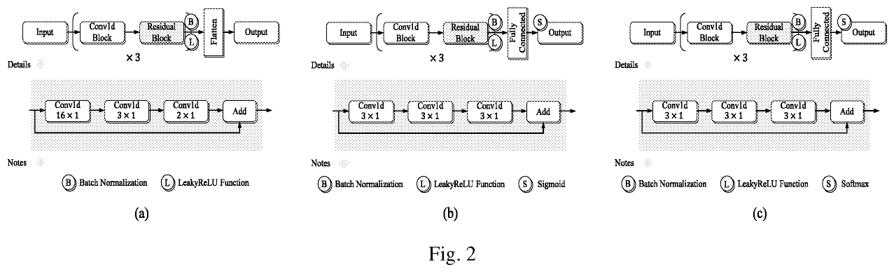

A multi-working-condition fault diagnosis model is composed of the Bayesian generator, the Bayesian discriminator and Bayesian classifier, and a network structure is shown in FIG. 2. In a training process of the multi-working-condition fault diagnosis model, the total number of iterations is 5000; in each loop, the discriminator is trained 10 times, and the generator is trained once; and a batch size is 128.

### 2. Diagnosis Result Assessment

In order to comprehensively evaluate the performance of the BSDG algorithm, in the present disclosure, experiments are conducted in scenarios of multi-source domain generalization and single-source domain generalization.

### 1) Multi-Source Domain Generalization Diagnosis Results

Table 1 shows the multi-source domain generalization diagnosis results. From the table, it can be found that the BSDG algorithm proposed by the present disclosure surpasses the other seven comparative algorithms with significant advantages. Specifically: empirical risk minimization (ERM), as a comparative algorithm without any domain adaptive operation, although the ERM may show stable performance in specific tasks, the ERM does not show satisfactory diagnosis results in domain generalization tasks; and compared with an optimal domain adaptive algorithm CORAL, the accuracy of the BSDG algorithm is improved by 16.7%. This means that a standard distribution alignment method has difficulty in generalizing the ability to reduce distribution differences to any unknown target domain; and compared with an optimal domain generalization algorithm SSAA, the accuracy of the BSDG algorithm is improved by 9.7%. On one hand, the Bayesian neural network effectively enhances the diversity and authenticity of the attack samples by constructing a set including a plurality of generators. On the other hand, when combined with the margin loss, the Bayesian neural network effectively resists the domain perturbations contained in the attack samples, expands the decision boundary of the classifier, and further reduces the distribution difference between the attack samples and the source-domain samples.

Through comparison with the performance of seven fault diagnosis models, the performance of the multi-working-condition fault diagnosis model of the present disclosure may be proved, and experimental results are shown in Table 1 to 3. Table 1 shows the multi-source domain generalization diagnosis results. The experimental results show that compared with the optimal comparative algorithm 7, the accuracy of the algorithm of the present disclosure is improved by 9.7%. On one hand, the Bayesian neural network effectively enhances the diversity and authenticity of the attack samples by constructing the set including the plurality of generators. On the other hand, when combined with the margin loss, the Bayesian neural network effectively resists the domain perturbations contained in the attack samples, expands the decision boundary of the classifier, and further reduces the distribution difference between the attack samples and the source-domain samples.

### 2) Single-Source Domain Generalization Diagnosis Results

Table 2 and Table 3 validate the diagnosis performance of the BSDG algorithm and the comparative algorithms in single-source domain generalization tasks. Table 2 lists transfer tasks between three different domains in NPWD. Table 3 records transfer tasks between different domains in NPWD and AWD. Table 2 and Table 3 validate the diagnosis performance of the algorithm in the present disclosure and the comparative algorithms in the single-source domain generalization tasks. Table 2 lists the transfer tasks between the three different domains in NPWD. Table 3 records the transfer tasks between the different domains in NPWD and AWD. The algorithm in the present disclosure achieves the highest accuracy in two task settings. In Table 3, the average accuracy of the proposed BSDG algorithm across six tasks is 68.56%, showing an improvement of 27.9% over the second-ranked SSAA algorithm.

The experimental results show that the introduction of the Bayesian neural network can better help the generator accurately simulate different unknown target domain features in real scenarios, and the use of the margin difference loss also makes the classifier flexibly and effectively cope with frequent distribution changes, thereby improving the adaptability and robustness of the classifier to the plurality of domain perturbations.

TABLE 1
Multi-source domain generalization experimental results (%). The best results are marked in bold.

| | | | | | | | | | The |
|---|---|---|---|---|---|---|---|---|---|
| Source | Target | Contrast | Contrast | Contrast | Contrast | Contrast | Contrast | Contrast | present |
| domain | domain | 1 | 2 | 3 | 4 | 5 | 6 | 7 | disclosure |
| HP + MP + | LP | 74.38 | 76.98 | 77.32 | 75.44 | 73.70 | 75.96 | 83.28 | 89.43 |
| AW | | | | | | | | | |
| HP + MP + LP | AW | 73.75 | 73.75 | 75.08 | 75.50 | 73.32 | 76.18 | 79.04 | 89.82 |
| HP + LP + | MP | 70.80 | 74.42 | 72.68 | 80.82 | 72.06 | 77.88 | 78.54 | 86.52 |
| AW | | | | | | | | | |
| MP + LP + AW | HP | 73.90 | 73.38 | 75.54 | 75.08 | 70.32 | 75.58 | 78.78 | 85.13 |

| | | | | | | | | |
|---|---|---|---|---|---|---|---|---|
| Mean | 73.21 | 74.63 | 75.16 | 76.71 | 72.35 | 76.40 | 79.91 | 87.73 |

TABLE 2
Single-source domain generalization experimental results (negative pressure wave data).
The best results are marked in bold.

| Source | Target | | | | | The present |
|---|---|---|---|---|---|---|
| domain | domain | Contrast 4 | Contrast 5 | Contrast 6 | Contrast 7 | disclosure |
| HP | MP | 75.10 | 74.86 | 75.70 | 80.74 | 84.28 |
| HP | LP | 71.42 | 67.48 | 75.90 | 80.94 | 83.95 |
| MP | HP | 66.98 | 71.17 | 72.30 | 79.02 | 81.05 |
| MP | LP | 72.12 | 72.66 | 72.24 | 70.18 | 83.01 |
| LP | HP | 74.98 | 68.34 | 75.04 | 78.06 | 81.18 |
| LP | MP | 72.28 | 66.48 | 70.90 | 81.70 | 81.09 |

| | | | | | |
|---|---|---|---|---|---|
| Mean | 72.15 | 70.17 | 73.68 | 78.44 | 82.43 |

TABLE 3
Single-source domain generalization experimental results (acoustic wave data and negative
pressure wave data). The best results are marked in bold.

| Source | Target | | | | | The present |
|---|---|---|---|---|---|---|
| domain | domain | Contrast 4 | Contrast 5 | Contrast 6 | Contrast 7 | disclosure |
| HP | AW | 44.64 | 43.90 | 39.18 | 54.34 | 72.91 |
| MP | AW | 54.78 | 45.12 | 49.95 | 53.48 | 71.43 |
| LP | AW | 45.84 | 43.64 | 53.52 | 55.34 | 70.51 |
| AW | HP | 44.08 | 45.06 | 24.48 | 51.84 | 65.35 |
| AW | MP | 45.02 | 39.06 | 45.36 | 57.32 | 67.92 |
| AW | LP | 37.26 | 37.24 | 36.70 | 49.12 | 63.23 |

| | | | | | |
|---|---|---|---|---|---|
| Mean | 45.30 | 42.34 | 41.53 | 53.57 | 68.56 |

### 3. Stability Performance Assessment

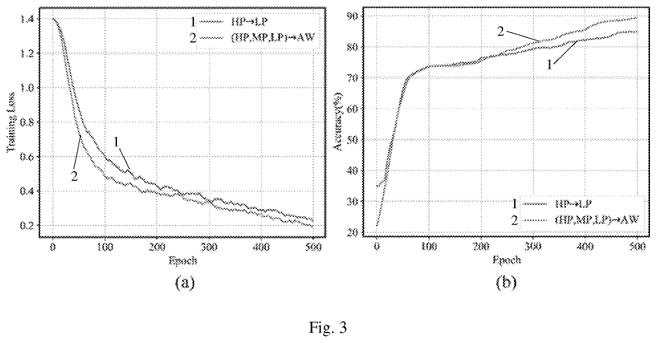

In order to validate the stability of the proposed algorithm, a training loss and validation accuracy of the multi-source domain generalization task (HP+MP+LP)→AW and the single-source domain generalization task HIP→LP are recorded in the present disclosure, as shown in FIG. 3. FIG. 3(a) shows that the training loss of the algorithm in the present disclosure rapidly decreases to a very small value with a stable trend in the above-mentioned two tasks. In addition, FIG. 3 (b) shows that the validation accuracy of the algorithm of the present disclosure can quickly reach a high value during the training process. Therefore, it can be found that the algorithm of the present disclosure can stably generalize source-domain diagnostic knowledge to the unknown target domain.

### 4. Significance Analysis

In order to validate the effectiveness of the proposed algorithm in improving a domain generalization effect, a paired sample t test is performed on single-source domain generalization results in the present disclosure to quantitatively validate the significant improvement brought by the proposed BSDG algorithm compared with strong comparative algorithms. The paired sample t test is a parametric statistical method configured to compare means of results from the same set of samples after processing by two algorithms. Steps of performing the test include: firstly, calculating a difference of diagnosis results of each sample after processing by the two algorithms; secondly, calculating a mean and a standard deviation of these differences; and then, dividing the mean of the differences by a standard error to obtain a t value. Finally, a p value in a distribution table t is calculated according to degrees of freedom to determine whether the means of the diagnosis results of the two algorithms are statistically significant. If the p value is less than a preset significance level, it is considered that the means of the diagnosis results under the two algorithms are statistically significant. According to the convention, a significance threshold is set to 0.05 in the present disclosure, that is, p≤0.05 means that the BSDG algorithm exhibits a significant performance improvement, and p>0.05 means that the BSDG algorithm has similar performance to the comparative algorithms.

The experimental results in Table 1, Table 2, and Table 3 are named Case1, Case2, and Case3, respectively. Statistical results show that the performance of the BSDG algorithm is only similar to that of the SSAA algorithm in Case2, while far better than that of the comparative algorithms in other scenarios.

TABLE 4
Paired sample t test significance test

| | Case 1 | | Case 2 | | Case 3 | |
|---|---|---|---|---|---|---|
| Algorithm | p-value | Result | p-value | Result | p-value | Result |
| GroupDRO | 0.012 | + | 0.000 | + | 3.265e−05 | + |
| MLDG | 5.918e−05 | + | 0.000 | + | 5.458e−06 | + |
| DIFEX | 0.003 | + | 4.720e−05 | + | 0.000 | + |
| SSAA | 0.005 | + | 0.0863 | − | 6.057e−05 | + |

“+” indicates that the performance of the proposed algorithm is significantly better than that of the comparative algorithms, and
“−” indicates similar performance

The present disclosure provides a novel natural gas pipeline fault diagnosis method based on Bayesian single-source domain generalization. Firstly, in the non-directional attack phase, through adversarial learning between the Bayesian generator and the Bayesian discriminator, diversified and smooth disturbances are introduced into the source-domain samples, so as to construct approximately real pseudo-target domain samples, which are configured to mislead a determination result of the classifier. Further, in the model defense phase, the margin difference loss is configured to enlarge the distance between the pseudo-domain samples and the original decision boundary of the classifier, thereby forming a new decision boundary that may contain all unknown samples. Through the attack and defense strategy, the BSDG algorithm can learn feature representations with obvious discriminability and high transferability from the pseudo-domain samples, and then effectively generalize to any unknown target domain in real scenarios. The experimental results show that compared with current advanced methods, the BSDG algorithm proposed in this study shows significant performance advantages in the application scenarios of multi-source domain and single-source domain generalization.

In summary, the method proposed by the present disclosure not only can solve the problem about small samples in the field of natural gas pipeline fault diagnosis, but also has better diagnosis performance and stability than existing comparison methods, thereby effectively reducing a risk of missed alarm and false alarm, and improving the accuracy of pipeline fault diagnosis. Through simulation experiments and practical applications for the method in the present disclosure, technical effects and practicability claimed by the present disclosure are verified.

Through the simulation experiments and practical applications for the method in the present disclosure, the technical effects claimed by the present disclosure are verified.

The algorithm (method) proposed by the present disclosure serves as an underlying technical core of the present disclosure, and various products can be derived based on the algorithm.

Based on the algorithm (method) proposed by the present disclosure, a multi-working-condition fault diagnosis system for a natural gas pipeline based on Bayesian adversarial attack and single-source domain transfer is developed by using a program language. The system has a program device corresponding to the steps of the above-mentioned technical solution, and the steps of the above-mentioned multi-working-condition fault diagnosis method for a natural gas pipeline based on Bayesian adversarial attack and single-source domain transfer are performed when running.

A computer program of the developed system (software) is stored on a computer-readable storage medium. The computer program is configured to implement the steps of the above-mentioned multi-working-condition fault diagnosis method for a natural gas pipeline based on Bayesian adversarial attack and single-source domain transfer when called by a processor. That is, the present disclosure is materialized on a carrier to become a computer program product.

A natural gas pipeline multi-working-condition fault diagnosis device is provided. A seismic information processing device includes at least one processor, and a memory which is in communication connection with the at least one processor, where the memory stores instructions executable by the at least one processor, the instructions, when executed by the at least one processor, cause the at least one processor to perform the above-mentioned multi-working-condition fault diagnosis method for a natural gas pipeline based on Bayesian adversarial attack and single-source domain transfer, and implement multi-working-condition fault diagnosis of the natural gas pipeline. The natural gas pipeline multi-working-condition fault diagnosis device is used as a terminal product for the application of the present disclosure.

The various implementations of the systems and technologies described herein may be implemented in a digital electronic circuit system, an integrated circuit system, a dedicated application-specific integrated circuit (ASIC), computer hardware, firmware, software, and/or combinations thereof. These various implementations may include implementing in one or more computer programs. The one or more computer programs may be executed and/or interpreted on a programmable system including at least one programmable processor. The programmable processor may be a dedicated or general-purpose programmable processor capable of receiving data and instructions from a storage system, at least one input apparatus, and at least one output apparatus, and transmitting the data and the instructions to the storage system, the at least one input apparatus, and the at least one output apparatus.

Computing programs (also referred to as programs, software, software applications, or code) in the present disclosure include machine instructions of the programmable processor, and these computing programs may be implemented using high-level procedural and/or object-oriented programming languages, and/or assembly/machine languages. As used in the present disclosure, the terms “machine-readable medium” and “computer-readable medium” refer to any computer program product, device, and/or apparatus (e.g., a magnetic disk, an optical disk, a memory, and a programmable logic device (PLD)) for providing the machine instructions and/or the data to the programmable processor, including the machine-readable medium that receives machine instructions as machine-readable signals. The term “machine-readable signal” refers to any signal configured to provide the machine instructions and/or the data to the programmable processor.

It should be understood that the various forms of process flows illustrated above may be used to allow for the steps to be reordered, added, or deleted. For example, the steps recorded in this application may be performed in parallel, or performed in sequence, or performed in different sequences, which all fall within the scope of protection of the present disclosure as long as results expected by the technical solutions disclosed in this application can be implemented.

What is claimed is:

1. A multi-working-condition fault diagnosis method for a natural gas pipeline based on Bayesian adversarial attack and single-source domain transfer, wherein an implementation process comprises:
step 1: collecting natural gas pipeline monitoring signals and constructing a training data set, wherein:
a pipeline negative pressure wave monitoring signal and an acoustic wave monitoring signal are acquired by using a natural gas pipeline network monitoring system, and a training set
$${𝒟}_{s} = {\{ {x}_{s}^{( i )} , {y}_{s}^{( i )} \}}_{i = 1}^{{N}_{s}}$$
is constructed by using any domain signal, wherein
$${x}_{s}^{( i )}$$
is an i-th original pipeline sample,
$${y}_{s}^{( i )}$$
is an i-th sample label, and Nₛ is the number of samples;
step 2: establishing a Bayesian generator to increase domain perturbations by maximizing a classification error to ensure the effectiveness of the attack, wherein:
a Bayesian network is used to construct the generator, and attack samples are generated by maximizing a class label classification loss and minimizing a domain label discrimination loss, and a Bayesian learning method is adopted to marginalize weights of a generative network to introduce uncertainty, which is used to stabilize the training of the Bayesian generator and improve the diversity of the attack samples, and
a posterior distribution of generator network parameters is inferred, and sampling is performed from the following conditional posterior distribution:
p(θ_{g}|xₛ,θ_{d},θ_{c})∝exp(−U_{attack}(θ_{d},θ_{c}|xₛ,θ_{g}))p(θ_{g}|α_{g}) (1)
wherein p(θ_{g}|xₛ,θ_{d},θ_{c}) is the posterior distribution of the generator network parameters, p(θ_{g}|α_{g}) is a prior distribution of the generator network parameters; θ_{g}~p(θ_{g}) represent network parameters of a generator g, θ_{d}~p(θ_{d}) represent network parameters of a discriminator d, and θ_{c}~p(θ_{c}) represent network parameters of a classifier c; and α_{g} is a hyperparameter; and
U_{attack}(θ_{d},θ_{c}|xₛ,θ_{g}) is a loss function of the generator, with a specific form:
$${U}_{attack} ( {θ}_{d} , {θ}_{c} \vert {x}_{s} , {θ}_{g} ) = - {\sum }_{i = 1}^{{J}_{g}} ( {\sum }_{m = 1}^{M} log p ( {y}_{d , m}^{( i )} \vert G ( {x}_{s}^{( i )} ; {θ}_{g} ) , {θ}_{d} ) - {\sum }_{n = 1}^{N} log p ( {y}_{c , n}^{( i )} \vert G ( {x}_{s}^{( i )} ; {θ}_{g} ) , {θ}_{c} ) ) \qquad ( 2 )$$
wherein
$$G ( {x}_{s}^{( i )} ; {0}_{g} )$$
represents an attack sample; J_{g} is the number of mini-batch samples for the generator, M is the number of domain labels, and N is the number of category labels; and y_{d,m} represents an m-th domain label, and y_{c,n} represents an n-th fault class label;
step 3: establishing a Bayesian discriminator to ensure the concealment of the attack through adversarial learning with the generator, wherein:
a domain discriminator based on the Bayesian network is established for assisting in generating attack samples with high concealment, a posterior distribution of discriminator network parameters is inferred, and sampling is performed from the following conditional posterior distribution:
p(θ_{d}|xₛ,θ_{g})∝exp(−U_{discriminate}(θ_{g};xₛ,θ_{d}))p(θ_{d}|α_{d}) (3)
wherein, p(θ_{d}|xₛ,θ_{g}) is the posterior distribution of the discriminator network parameters, α_{d} is a hyperparameter, and U_{discriminate}(θ_{g};xₛ,θ_{d}) is a loss function of the discriminator, with a specific form:
$${U}_{discriminate} ( {θ}_{g} ; {x}_{s} , {θ}_{d} ) = - {\sum }_{i = 1}^{{J}_{g}} {\sum }_{m = 1}^{M} ( log p ( {y}_{d , m}^{( i )} \vert {x}_{s}^{( i )} , {θ}_{d} ) + log ( 1 - p ( {y}_{d , m}^{( i )} \vert G ( {x}_{s}^{( i )} ; {θ}_{g} ) , {θ}_{d} ) ) ) \qquad ( 4 )$$
wherein J_{d} is the number of mini-batch samples for the discriminator;
step 4: establishing a Bayesian classifier to resist the attack and improve generalizability by expanding a decision boundary of an original classifier, wherein:
a designed defense strategy comprises two parts, the first part is a classification loss based on cross entropy, firstly, a joint distribution p(Xₛ,Yₛ,Xₐ,Yₐ) of original samples and the attack samples needs to be constructed, and then the classification loss is optimized to accurately identify each sample in the joint distribution, namely:
p(θ_{c}|xₛ,xₐ,θ_{g})∝exp(−U_{defense}(θ_{c}))p(θ_{c}|α_{c}) (5)
wherein p(θ_{c}|xₛ,xₐ,θ_{g}) represents a posterior distribution of classifier network parameters, ac is a hyperparameter, and U_{defense}(θ_{c}) is a loss function of the classifier, with a specific form:
$${U}_{d e f e n s e} ( {θ}_{c} ) = - {\sum }_{i = 1}^{{J}_{c}} {\sum }_{n = 1}^{N} log p ( {y}_{c , n}^{( i )} \vert {\hat{x}}_{s}^{( i )} , {θ}_{c} ) \qquad ( 6 )$$
wherein \hat{x}ᵢ∈p(Xₛ,Yₛ,Xₐ,Yₐ) represents any sample in the joint distribution; the second part is a margin difference loss; a margin is defined as a minimum distance from a data point to the decision boundary; and using the margin difference loss is capable of enlarging a distance between the attack samples and an original decision boundary of the classifier, and constraining the posterior distribution of the classifier network parameters to adjust to a direction of a higher score for the attack samples, so as to enhance the adaptability and robustness of the model when facing distribution differences under different working conditions;
the defense strategy based on the margin loss is configured to improve identification accuracy of the classifier for samples under different working conditions; and a regularized loss based on the margin difference is capable of being represented as:
$${max}_{{θ}_{c}} {ℛ}_{m a r} = \frac{1}{{J}_{c}} {\sum }_{i = 1}^{{J}_{c}} {‖ φ ( {err}_{{p}_{a}}^{( ρ )} ( ( c ) ) - φ ( {err}_{{p}_{a}}^{( ρ )} ( f ) ) ‖}_{ℋ}^{2} \qquad ( 7 )$$
wherein
$${err}_{{p}_{a}}^{( ρ )} ( c ) and {err}_{{p}_{a}}^{( ρ )} ( f )$$
represent a transfer classifier margin and a pre-trained classifier margin related to an attack sample distribution p(Xₐ), respectively, and f represents a pre-trained classifier; and a specific calculation formula for the margin is:
$$e r {r}_{{p}_{a}}^{( ρ )} ( c ) = \frac{1}{n} {\sum }_{i = 1}^{n} {Φ}_{ρ} ( {ρ}_{c} ( {x}_{a}^{( i )} , {y}_{a}^{( i )} ) ) \qquad ( 8 )$$
wherein ρ_{c}(xₐ,yₐ) is a decision boundary of the classifier, with a calculation method as:
$${ρ}_{c} ( {x}_{a} , {y}_{a} ) {=}^{△} \frac{1}{2} ( c ( {x}_{a} , {y}_{a} ) - {max}_{{y}_{a}^{′} = {y}_{a}} c ( {x}_{a} , {y}_{a}^{′} ) ) \qquad ( 9 )$$
wherein y′ₐ is a correct classification label given by the classifier for the attack sample xₐ, and y′ₐ is a wrong classification label given by the classifier for the attack sample xₐ; and Φₚ(ρ_{c}(xₐ,yₐ)) is a piecewise function, which is configured to promote the classifier to generate a large positive margin value, that is, to make a score of a correct category as high as possible than scores of other categories, and a specific form is:
$${Φ}_{ρ} ( {ρ}_{c} ( {x}_{a} , {y}_{a} ) ) {=}^{△} \{ \begin{matrix}0 & ρ \leq {ρ}_{c} ( {x}_{a} , {y}_{a} ) \\ 1 - {ρ}_{c} ( {x}_{a} , {y}_{a} ) / ρ & 0 \leq {ρ}_{x} ( {x}_{a} , {y}_{a} ) < ρ \\ 1 & ρ ( {x}_{a} , {y}_{a} ) < 0\end{matrix} \qquad ( 10 )$$
wherein ρ is a margin lower bound;
step 5: estimating a weight posterior distribution using stochastic gradient Hamiltonian Monte Carlo (SGHMC) sampling, wherein:
a Bayesian network parameter optimizer is constructed using the stochastic gradient Hamiltonian Monte Carlo method to realize the alternating optimization of the generator, the discriminator, and the classifier, firstly, a network parameter optimizer is constructed based on the SGHMC, and then the Bayesian generator, the Bayesian discriminator, and the Bayesian classifier are trained alternately; and
step 6: obtaining a single-source domain transfer diagnosis model and completing pipeline network fault type identification, wherein:
the training of the single-source domain transfer diagnosis model is completed through the steps 1 to 5, and model performance is evaluated using set test data, and the test data is from pipelines with operating conditions different from those of training data.

2. The multi-working-condition fault diagnosis method for the natural gas pipeline based on Bayesian adversarial attack and single-source domain transfer according to claim 1, wherein in step 1, a specific process of acquiring the pipeline negative pressure wave monitoring signal and the acoustic wave monitoring signal, and constructing the training set by using any domain signal is as follows: firstly, acquiring the negative pressure wave monitoring signal and the acoustic wave monitoring signal respectively from the monitoring system, then acquiring a sample having a length of 1024 through a downsampling operation, denoising the acquired sample, and finally storing the negative pressure wave signal and the acoustic wave signal as two separate domains.

3. The multi-working-condition fault diagnosis method for the natural gas pipeline based on Bayesian adversarial attack and single-source domain transfer according to claim 1, wherein in step 2, the hyperparameter α_{g} is determined according to cross-validation; and a relationship between the network parameters of the generator g, the network parameters of the discriminator d, and the network parameters of the classifier c is an output result of the discriminator, the output result is configured to adjust an update direction of the generator, and a result of the generator is configured to improve generalization performance of the classifier.

4. The multi-working-condition fault diagnosis method for the natural gas pipeline based on Bayesian adversarial attack and single-source domain transfer according to claim 3, wherein in step 3, the hyperparameter α_{d} is determined according to cross-validation.

5. The multi-working-condition fault diagnosis method for the natural gas pipeline based on Bayesian adversarial attack and single-source domain transfer according to claim 4, wherein in step 4, the margin lower bound ρ is related to model accuracy, and the margin lower bound ρ is determined through a plurality of experiments.

6. The multi-working-condition fault diagnosis method for the natural gas pipeline based on Bayesian adversarial attack and single-source domain transfer according to claim 5, wherein in step 5, the Bayesian network parameter optimizer is constructed using the stochastic gradient Hamiltonian Monte Carlo method to realize the alternating optimization of the generator, the discriminator, and the classifier.

7. The multi-working-condition fault diagnosis method for the natural gas pipeline based on Bayesian adversarial attack and single-source domain transfer according to claim 6, wherein a specific process of constructing the Bayesian network parameter optimizer using the stochastic gradient Hamiltonian Monte Carlo (SGHMC) method to realize the alternating optimization of the generator, the discriminator, and the classifier is as follows:
according to a previous round of iteration process, obtaining parameters θ_{g},θ_{d},θ_{c}, that need to be currently updated:
$${\{ {θ}_{g}^{i , k} \}}_{i = 1 , k = 1}^{{J}_{g} , K} , {\{ {θ}_{d}^{i , k} \}}_{i = 1 , k = 1}^{{J}_{d} , K} and {\{ {θ}_{c}^{i , k} \}}_{i = 1 , k = 1}^{{J}_{c} , K}$$
then, starting an attack training loop, wherein:
J_{g} times of SGHMC training are started, J_{g} source-domain samples
$$\{ {x}_{s}^{( 1 )} , {x}_{s}^{( 2 )} , … , {x}_{s}^{( {J}_{g} )} \}$$
are sampled from a source-domain distribution p(Xₛ), and a parameter posteriori distribution p(θₚ|xₛ,θ_{d}) is updated through K iterations of the SGHMC, and
$${θ}_{g}^{i , k} ← {θ}_{g}^{i , k} + v ; v ← ( 1 - α ) v + η \frac{\partial ( {\sum }_{i} {\sum }_{k} p ( {θ}_{g} \vert {x}_{s}^{( i )} , {θ}_{d}^{i , k} , {θ}_{c}^{i , k} ) )}{\partial {θ}_{g}} + n ;$$
$$n ∼ 𝒩 ( 0 , 2 αη I )$$
$${θ}_{g}^{i , k}$$
is added to a parameter set to end the loop;
J_{d} iterations of SGHMC training are started:
J_{d} source-domain samples
$$\{ {x}_{s}^{\{ 1 )} , {x}_{s}^{\{ 2 )} , … , {x}_{s}^{( {J}_{d} )} \}$$
are sampled from the source-domain distribution, and a parameter posteriori distribution p(θ_{d}|xₛ,θ_{g}) is updated through K iterations of the SGHMC, and
$${θ}_{d}^{i , k} ← {θ}_{d}^{i , k} + v ; v ← ( 1 - α ) v + η \frac{\partial ( {\sum }_{i} {\sum }_{k} p ( {θ}_{d} \vert {x}_{s}^{( i )} , {θ}_{g}^{i , k} ) )}{\partial {θ}_{d}} + n ;$$
$$n ∼ 𝒩 ( 0 , 2 αη I )$$
$${θ}_{d}^{i , k}$$
is added to the parameter set to end the attack training loop; and
then, starting a defense training loop, wherein:
J_{c} augmented samples
$$\{ {\hat{x}}_{s}^{( 1 )} , {\hat{x}}_{s}^{( 2 )} , … , {\hat{x}}_{s}^{( {J}_{c} )} \}$$
are sampled from a joint domain distribution p(Xₛ,Xₐ), and a parameter posteriori distribution p(θ_{c}|xₛ,xₐ,θ_{g}) is updated through K iterations of the SGHMC, and
$${θ}_{c}^{i , k} ← {θ}_{c}^{i , k} + v ;$$
$$v ← ( 1 - α ) v + η \frac{\partial ( {\sum }_{i} {\sum }_{k} p ( {θ}_{c} \vert {x}_{s}^{( i )} , {x}_{a}^{( i )} , {θ}_{g}^{i , k} ) - {ℛ}_{mar} )}{\partial {θ}_{c}} + n ;$$
$$n ∼ 𝒩 ( 0 , 2 αη I )$$
the defense training loop is ended; and
in the above-mentioned formula, α is a momentum attenuation coefficient of the SGHMC, η is a learning rate, v=ϵM⁻¹r is a kinetic energy term of the SGHMC, and 2αηI represents a variance.
